(19) United States
(12) Patent Application Publication
(10) Pub. No.: US 2026/0226982 A1
(43) Pub. Date: Aug. 6, 2026

(54) GASKET AND ELECTROCHEMICAL DEVICE

(71) Applicant: DAIKIN INDUSTRIES, LTD., Osaka (JP)

(72) Inventors: Masahiko YAMADA, Osaka (JP); Tomihiko YANAGIGUCHI, Osaka (JP); Taketo KATO, Osaka (JP)

(73) Assignee: DAIKIN INDUSTRIES, LTD., Osaka (JP)

(21) Appl. No.: 19/630,745

(22) Filed: Mar. 27, 2026

Related U.S. Application Data
(63) Continuation of application No. PCT/JP2024/034990, filed on Sep. 30, 2024.

(30) Foreign Application Priority Data
Sep. 29, 2023 (JP) 2023-169988

(51) Int. Cl. F16J 15/10; H01M 50/193

(52) U.S. Cl. CPC F16J 15/102; H01M 50/193

(57) ABSTRACT

A gasket with excellent water vapor barrier properties, and an electrochemical device including the gasket. A gasket containing polytetrafluoroethylene exhibiting non-melt-moldability, the gasket having a water vapor transmission coefficient of 0.020 g/1000 hr or less.

### CROSS REFERENCE TO RELATED APPLICATIONS

This application is a Rule 53(b) Continuation of International Application No. PCT/JP2024/034990 filed on Sep. 30, 2024, which claims priority to Japanese Patent Application No. 2023-169988 filed on Sep. 29, 2023, the disclosures of which are incorporated herein by reference in their respective entireties.

### TECHNICAL FIELD

The disclosure relates to gaskets and electrochemical devices.

### BACKGROUND ART

It is known that resins such as perfluoroalkoxy alkane (PFA) are used as sealing members (gaskets) for electrochemical devices such as lithium ion secondary batteries (see Patent Literatures 1 to 4, for example).

### CITATION LIST

### Patent Literature

Patent Literature 1: JP 2017-174732 A
Patent Literature 2: WO 2020/066050
Patent Literature 3: WO 2014/049645
Patent Literature 4: JP 2021-141045 A

### SUMMARY

The disclosure (1) relates to a gasket containing polytetrafluoroethylene exhibiting non-melt-moldability, the gasket having a water vapor transmission coefficient of 0.020 g/1000 hr or less.

### Advantageous Effects

The disclosure can provide a gasket with excellent water vapor barrier properties and an electrochemical device including the gasket.

### BRIEF DESCRIPTION OF DRAWINGS

FIG. 1 is a schematic cross-sectional view showing the configuration of a portion of an electrochemical device including a gasket.

FIG. 2 is a schematic cross-sectional view of a transmission test jig used in a water vapor transmission test.

### DESCRIPTION OF EMBODIMENTS

Conventionally, PFA and similar materials have been used in gaskets with excellent water vapor barrier properties. In contrast, polytetrafluoroethylene (PTFE) is considered poor in water vapor barrier properties, though it is excellent in chemical resistance and heat resistance. It has been discovered that, even when a gasket is formed from PTFE, the water vapor transmission can be surprisingly reduced.

The disclosure is described in detail below.

The disclosure provides a gasket containing PTFE exhibiting non-melt-moldability, the gasket having a water vapor transmission coefficient of 0.020 g/1000 hr or less (hereafter, also referred to as gasket (1) of the disclosure).

The gasket (1) of the disclosure, the later-described gasket (2) of the disclosure, and the later-described gasket (3) of the disclosure are herein collectively referred to as “gasket of the disclosure”, unless otherwise stated.

The gasket (1) of the disclosure having the above structure has excellent water vapor barrier properties. In addition, the gasket (1) of the disclosure containing PTFE is excellent in chemical resistance and heat resistance.

The gasket (1) of the disclosure has a water vapor transmission coefficient of 0.020 g/1000 hr or less. In order to further improve the water vapor barrier properties, the water vapor transmission coefficient is preferably 0.015 g/1000 hr or less, more preferably 0.012 g/1000 hr or less, still more preferably 0.010 g/1000 hr or less, further preferably 0.009 g/1000 hr or less, further preferably 0.008 g/1000 hr or less, further preferably 0.007 g/1000 hr or less, further preferably 0.006 g/1000 hr or less, particularly preferably 0.004 g/1000 hr or less, while it may be 0.0001 g/1000 hr or more.

The water vapor transmission coefficient is determined by measuring the mass of water passing through a ring-shaped gasket with a rectangular cross section, an outer diameter of 17.7 mm, an inner diameter of 14.3 mm, and a thickness of 1.6 mm, at a compression ratio of 40% under the conditions of 80° C. for 1000 hours.

The compression ratio can be calculated using the following formula.

$$Compression ratio ( \% ) = [ ( Thickness of gasket before compression ) - ( Thickness of gasket after compression ) ] / ( Thickness of gasket before compression ) \times 100$$

When a gasket installed in an electrochemical device is used for the measurement, the installed gasket is taken out and subjected to the heat treatment at 150° C. for 24 hours, and with the thickness of the resulting gasket taken as the thickness of the gasket before compression, the gasket is compressed to the above-mentioned compression ratio for the measurement.

The water vapor transmission coefficient is a value measured at a compression ratio of 40%. In order to further improve the water vapor barrier properties, the water vapor transmission coefficient is preferably a value measured at a compression ratio of 30%, more preferably a value measured at a compression ratio of 25%, still more preferably a value measured at a compression ratio of 20%, further preferably a value measured at a compression ratio of 15%.

The disclosure also provides a gasket for an electrochemical device containing PTFE exhibiting non-melt-moldability, the gasket having a specific gravity of 2.130 or more and 2.180 or less (hereafter, also referred to as gasket (2) of the disclosure).

The gasket (2) of the disclosure having the above structure has excellent water vapor barrier properties. In addition, the gasket (2) of the disclosure containing PTFE is excellent in chemical resistance and heat resistance.

The gasket (2) of the disclosure has a specific gravity of 2.130 or more and 2.180 or less. In order to further improve the water vapor barrier properties, the specific gravity is preferably 2.175 or less, more preferably 2.170 or less, still more preferably 2.165 or less, further preferably 2.160 or less, while it is preferably 2.135 or more, more preferably 2.140 or more.

The specific gravity is measured by the water displacement method in conformity with ASTM D792. The specific gravity of the gasket of the disclosure may be measured either before or after the water vapor transmission measurement.

The specific gravity of the gasket can be adjusted by firing conditions upon molding. As the temperature drop rate during firing of the gasket increases, the gasket has a lower degree of crystallinity and a smaller specific gravity. The gasket having a small specific gravity, that is, having a small degree of crystallinity is excellent in water vapor barrier properties. The reason for this is presumably as follows. As the specific gravity becomes greater, the degree of crystallinity becomes higher and the proportion of molecular chains forming the amorphous portion becomes smaller. This leads to the presence of many minute voids and increased water vapor transmission in the amorphous portion. As a result, the water vapor barrier properties of the gasket are impaired.

The disclosure also provides a gasket for an electrical device containing PTFE exhibiting non-melt-moldability, the gasket having a degree of crystallinity of 65% or less and a scattering intensity of 800 or more (hereafter, also referred to as gasket (3) of the disclosure).

The gasket (3) of the disclosure having the above structure has excellent water vapor barrier properties. In addition, the gasket (3) of the disclosure containing PTFE is excellent in chemical resistance and heat resistance.

The gasket (3) of the disclosure has a degree of crystallinity of 65% or less. In order to further improve the water vapor barrier properties, the degree of crystallinity is preferably 62% or lower, more preferably 60% or lower, still more preferably 58% or lower. The lower limit is not limited. Still, the degree of crystallinity is preferably 30% or higher, more preferably 35% or higher, still more preferably 38% or higher, further preferably 40% or higher.

The degree of crystallinity is measured using an X-ray diffractometer (Ultima III, available from Rigaku Corporation) by a multiple peak separation method under the following measurement conditions. A measurement sample with a thickness of 40 μm or more is set in a sample holder, and the peaks of the crystalline and amorphous portions of the obtained diffraction spectrum are separated into independent peaks. The integrated intensity (area) of each peak is determined to calculate the degree of crystallinity.

### Measurement Conditions

TABLE 1

| Radiation source: | CuKα radiation: λ = 1.5418 Å |
|---|---|
| Output power: | 40 kV/40 mA |
| Measurement range: | 5° to 55° |
| STEP width: | 0.02° |

The gasket having a low degree of crystallinity is excellent in water vapor barrier properties. It is expected that a gasket with a higher degree of crystallinity will have better water vapor barrier properties. However, it was surprisingly found that a gasket with a lower degree of crystallinity has better water vapor barrier properties. The reason for this is presumably as follows. As the degree of crystallinity becomes greater, the proportion of molecular chains forming the amorphous portion becomes smaller. This leads to the presence of many minute voids and increased water vapor transmission in the amorphous portion. As a result, the water vapor barrier properties of the gasket are impaired.

The degree of crystallinity can be adjusted by conditions for molding PTFE contained in the gasket. The degree of crystallinity may be measured on the gasket after molding or on the removed gasket. This is because there is almost no change in the degree of crystallinity before and after the water vapor transmission measurement. After the water vapor transmission measurement, the scattering intensity increases, which suggests the formation of pseudo-crystals. However, since only a small number of pseudo-crystals are formed, this does not appear as a change in the degree of crystallinity.

The gasket (3) of the disclosure has a scattering intensity of 800 or more. In order to further improve the water vapor barrier properties, the scattering intensity is preferably 850 or more, more preferably 900 or more, still more preferably 1000 or more. The upper limit is not limited. Still, the scattering intensity is preferably 2000 or less, more preferably 1800 or less, still more preferably 1700 or less, further preferably 1600 or less, particularly preferably 1500 or less.

The scattering intensity is measured using a small angle X-ray diffractometer (RINT2500, available from Rigaku Corporation) under the following measurement conditions, and the scattering intensity at a scattering vector q of 0.07 nm⁻¹ is defined as the scattering intensity.

### Measurement Conditions

TABLE 2

| | |
|---|---|
| Radiation source: | CuKα radiation: λ = 1.5418 Å |
| Output power: | 50 kV/300 mA |
| Detector: | Scintillation counter |

The compression ratio upon installation can be estimated by measuring the scattering intensity in small angle X-ray diffraction measurement of the gasket removed from the test jig after the water vapor transmission test. When the compression ratio is high, new pseudo-crystals are generated in the amorphous portion of the PTFE contained in the gasket. After the test is completed, even when the compression is released, the scattering intensity is presumably increased due to the density difference between the newly formed pseudo-crystals and the amorphous portion in the PTFE. Since a high degree of compression improves the water vapor barrier properties, measuring the scattering intensity of the gasket after installation reveals that the gasket is excellent in water vapor barrier properties.

In order to further improve the water vapor barrier properties, the gasket (2) of the disclosure and the gasket (3) of the disclosure each preferably have a water vapor transmission coefficient of 0.010 g/1000 hr or less, more preferably 0.009 g/1000 hr or less, still more preferably 0.008 g/1000 hr or less, further preferably 0.007 g/1000 hr or less, further preferably 0.006 g/1000 hr or less, particularly preferably 0.004 g/1000 hr or less, while they each may have a water vapor transmission coefficient of 0.0001 g/1000 hr or more.

As described above, the water vapor transmission coefficient is a value measured at a compression ratio of 40%. In order to further improve the water vapor barrier properties, the water vapor transmission coefficient is preferably a value measured at a compression ratio of 30%, more preferably a value measured at a compression ratio of 25%, still more preferably a value measured at a compression ratio of 20%, further preferably a value measured at a compression ratio of 15%.

In order to further improve the water vapor barrier properties, the specific gravity of each of the gasket (1) of the disclosure and the gasket (3) of the disclosure may be 2.185 or less, and is preferably 2.180 or less, more preferably 2.175 or less, still more preferably 2.170 or less, further preferably 2.165 or less, further preferably 2.160 or less. The lower limit is not limited. Still, the specific gravity may be 2.130 or more, and is preferably 2.135 or more, more preferably 2.140 or more.

The specific gravity is measured by the water displacement method in conformity with ASTM D792. The specific gravity of the gasket of the disclosure may be measured either before or after the water vapor transmission measurement.

The gasket (1) of the disclosure and the gasket of the disclosure (2) each preferably have a degree of crystallinity of 65% or less, more preferably 62% or less, still more preferably 60% or less, further preferably 58% or less. The lower limit is not limited. Still, the degree of crystallinity is preferably 30% or more, more preferably 35% or more, still more preferably 38% or more, further preferably 40% or more.

The degree of crystallinity is measured by the above method.

In order to further improve the water vapor barrier properties, the gasket (1) of the disclosure and the gasket (2) of the disclosure each preferably have a scattering intensity of 800 or more, more preferably 850 or more, still more preferably 900 or more, particularly preferably 1000 or more. The upper limit is not limited. Still, the scattering intensity is preferably 2000 or less, more preferably 1800 or less, still more preferably 1700 or less, further preferably 1600 or less, particularly preferably 1500 or less.

The scattering intensity is measured by the above method.

The PTFE in the gasket of the disclosure exhibits non-melt-moldability.

The phrase “exhibits non-melt-moldability” herein means that the melt flow rate (MFR) is lower than 0.10 g/10 min, preferably lower than 0.01 g/10 min.

The MFR is a value obtained in conformity with ASTM D1238 using a melt indexer, as the mass (g/10 min) of a polymer flowing out of a nozzle (inner diameter: 2.095 mm, length: 8 mm) per 10 minutes at 372° C. and a load of 5000 g (total load).

The PTFE may be a homopolymer of tetrafluoroethylene (TFE) or a modified PTFE. In order to further improve the water vapor barrier properties, preferred is a modified PTFE. Also preferred is a tetrafluoroethylene homopolymer or a modified PTFE containing a modifying monomer unit in an amount of 0.01 to 0.10% by mass based on all polymerized units.

The modified PTFE preferably contains a TFE unit and 1.0% by mass or less of a modifying monomer unit. The amount of the TFE unit may be 99.0% by mass or more. The modified PTFE may consist of a TFE unit and a modifying monomer unit.

In order to further improve the water vapor barrier properties, the modified PTFE preferably contains a modifying monomer unit (modification amount) in an amount falling within a range of 0.00001 to 1.0% by mass based on all polymerized units. The lower limit of the amount of the modifying monomer unit is more preferably 0.0001% by mass, still more preferably 0.001% by mass, further preferably 0.005% by mass, even more preferably 0.010% by mass. The upper limit of the amount of the modifying monomer unit is preferably 0.90% by mass, more preferably 0.80% by mass, more preferably 0.50% by mass, still more preferably 0.40% by mass, further preferably 0.30% by mass, further preferably 0.20% by mass, particularly preferably 0.10% by mass.

The modifying monomer unit herein means a moiety that is part of the molecular structure of PTFE and is derived from a modifying monomer.

The amounts of the above polymerized units can be calculated by any appropriate combination of NMR, FT-IR, elemental analysis, and X-ray fluorescence analysis in accordance with the types of the monomers.

The modifying monomer may be any monomer copolymerizable with TFE. Examples thereof include a perfluoroolefin such as hexafluoropropylene (HFP); a hydrogen-containing fluoroolefin such as trifluoroethylene or vinylidene fluoride (VDF); a perhaloolefin such as chlorotrifluoroethylene (CTFE); a perfluorovinyl ether; a perfluoroallyl ether; a (perfluoroalkyl)ethylene; and ethylene. One modifying monomer may be used alone or two or more modifying monomers may be used in combination.

Examples of the perfluorovinyl ether include, but are not limited to, an unsaturated perfluoro compound represented by the following formula (A):

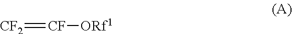

wherein Rf¹ is a perfluoro organic group. The term “perfluoro organic group” herein means an organic group in which all hydrogen atoms bonded to any carbon atom are replaced by fluorine atoms. The perfluoro organic group may have an ether oxygen.

Examples of the perfluorovinyl ether include a perfluoro (alkyl vinyl ether) (PAVE) represented by the formula (A) in which Rf¹ is a C1-C10 perfluoroalkyl group. The perfluoroalkyl group preferably has a carbon number of 1 to 5.

Examples of the perfluoroalkyl group in the PAVE include a perfluoromethyl group, a perfluoroethyl group, a perfluoropropyl group, a perfluorobutyl group, a perfluoropentyl group, and a perfluorohexyl group.

Examples of the perfluorovinyl ether also include:
those represented by the formula (A) wherein Rf¹ is a C4-C9 perfluoro (alkoxy alkyl) group;
those represented by the formula (A) wherein Rf¹ is a group represented by the following formula:

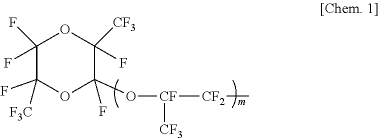

wherein m is an integer of 0 or 1 to 4; and
those represented by the formula (A) wherein Rf¹ is a group represented by the following formula:

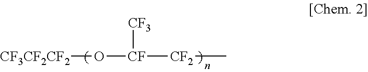

wherein n is an integer of 1 to 4.

Examples of the (perfluoroalkyl)ethylene (PFAE) include, but are not limited to, (perfluorobutyl)ethylene (PFBE) and (perfluorohexyl)ethylene.

Examples of the hydrogen-containing fluoroolefin include CH₂═CF₂, CFH═CH₂, CFH═CF₂, CH₂═CFCF₃, CH₂═CHCF₃, CHF═CHCF₃ (E-isomer), and CHF═CHCF₃ (Z-isomer).

Examples of the perfluoroallyl ether include fluoromonomers represented by the following formula (B):

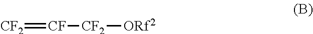

wherein Rf² is a perfluoro organic group.

Rf² is preferably a C1-C10 perfluoroalkyl group or a C1-C10 perfluoroalkoxyalkyl group. The perfluoroallyl ether preferably includes at least one selected from the group consisting of CF₂═CF—CF₂—O—CF₃, CF₂═CF—CF₂—O—C₂F₅, CF₂═CF—CF₂—O—C₃F₇, and CF₂═CF—CF₂—O—C₄F₉, more preferably includes at least one selected from the group consisting of CF₂═CF—CF₂—O—C₂F₅, CF₂═CF—CF₂—O—C₃F₇, and CF₂═CF—CF₂—O—C₄F₉, still more preferably CF₂═CF—CF₂—O—CF₂CF₂CF₃.

In order to further improve the water vapor barrier properties, the modifying monomer preferably includes at least one selected from the group consisting of PAVE, PFAE, and HFP, more preferably includes at least one selected from the group consisting of PAVE and HFP, still more preferably includes PAVE, further preferably includes perfluoro (propyl vinyl ether) (PPVE).

The PTFE may have a core-shell structure. An example of the PTFE having a core-shell structure is a modified PTFE including a core of high-molecular-weight PTFE and a shell of lower-molecular-weight PTFE or modified PTFE in a particle. Examples of this modified PTFE include PTFEs disclosed in JP 2005-527652 T.

In order to further improve the water vapor barrier properties, the PTFE preferably has a heat of crystallization measured by a differential scanning calorimeter (DSC) of 25 J/g or more, more preferably 26 J/g or more, still more preferably 27 J/g or more, while preferably 33 J/g or less, more preferably 32 J/g or less, still more preferably 30 J/g or less, particularly preferably 29 J/g or less.

The heat of crystallization is measured by the following method.

About 3 mg of a sample is precisely weighed out and placed in a dedicated aluminum pan. Using an X-DSC7000 (available from Hitachi High-Tech Science Corporation), the temperature is raised to 380° C. at a rate of 10° C./min in a nitrogen atmosphere, held at that temperature for one minute, and cooled to 250° C. at a rate of 10° C./min to measure the heat of crystallization at the crystallization point. The value of the heat of crystallization is determined by drawing a line from the 275° C. point to the 330° C. point on the obtained DSC chart and calculating the area enclosed by the curve including the peak and the line.

The gasket of the disclosure may contain a component other than the PTFE but preferably consists essentially of the PTFE. This allows remarkable exertion of the effect attributable to the PTFE. The phrase “consists essentially of the PTFE” means that the amount of the PTFE is 95.0% by mass or more based on the gasket.

The amount of the PTFE is preferably 98.0% by mass or more, more preferably 99.0% by mass or more, still more preferably 99.5% by mass or more, particularly preferably 99.9% by mass or more, most preferably 99.95% by mass or more based on the gasket.

The gasket of the disclosure also preferably consists of the PTFE.

The gasket of the disclosure preferably exhibits non-melt-moldability.

In order to further improve the water vapor barrier properties, the gasket of the disclosure has a compression ratio upon installation of 10% or more, more preferably 12% or more, still more preferably 17% or more, further preferably 25% or more, particularly preferably 35% or more, while preferably 65% or less, more preferably 60% or less.

The compression ratio can be calculated using the following formula.

$$Compression ratio ( \% ) = [ ( Thickness of gasket before compression ) - ( Thickness of gasket after compression ) ] / ( Thickness of gasket before compression ) \times 100$$

When a gasket installed in an electrochemical device is used for the measurement, the installed gasket is taken out and subjected to the heat treatment at 150° C. for 24 hours, and with the thickness of the resulting gasket taken as the thickness of the gasket before compression, the compression ratio is measured.

The gasket of the disclosure can be produced by molding a raw-material PTFE into a desired shape and firing the molded article. The raw-material PTFE may be in any form such as powder or a dispersion, and is preferably in the form of powder.

The standard specific gravity (SSG) of the raw-material PTFE is preferably 2.130 or more, more preferably 2.135 or more, still more preferably 2.140 or more, while it is preferably 2.180 or less, more preferably 2.175 or less, still more preferably 2.170 or less, further preferably 2.165 or less, particularly preferably 2.160 or less.

The SSG is determined by the water displacement method in conformity with ASTM D792 using a sample molded in conformity with ASTM D4895-89.

By setting the SSG within the above range, the water vapor transmission coefficient can be easily set within the above range.

The raw-material PTFE can be produced by emulsion polymerization or suspension polymerization. In particular, the raw-material PTFE is preferably produced by suspension polymerization.

Emulsion polymerization can be performed by a known method. For example, an aqueous dispersion containing particles (primary particles) of the PTFE is obtainable by emulsion polymerization of monomers (TFE and optionally a modifying monomer) to form the PTFE in an aqueous medium in the presence of a fluorine-containing anionic surfactant and a polymerization initiator. In the emulsion polymerization, additives such as a chain transfer agent, a buffer, a pH adjuster, a stabilization aid, a dispersion stabilizer, and a radical scavenger may be used as appropriate.

The resulting aqueous dispersion is coagulated to obtain a wet powder, and the wet powder is dried, whereby a raw-material PTFE powder can be obtained. Coagulation and drying may be performed by any known techniques.

Suspension polymerization may be performed by, for example, charging a reactor with a monomer such as TFE, an aqueous medium, and optionally other additives, stirring the contents in the reactor, maintaining the reactor at a predetermined polymerization temperature, and then adding a predetermined amount of a polymerization initiator to initiate the polymerization reaction. After the initiation of the polymerization reaction, the components such as the monomer such as TFE, the polymerization initiator, and a chain transfer agent may additionally be added depending on the purpose.

The resulting suspension polymerized particles may be washed and then pulverized, or the resulting suspension polymerized particles may be pulverized while being washed, to produce pulverized particles.

The wet pulverized particles may be dehydrated to be further dried. Drying is performed for the purpose of removing moisture from the pulverized particles obtained through pulverization.

The pulverized particles obtained by pulverizing suspension polymerized particles may be classified by a known method such as air classification.

The resulting pulverized particles may be granulated by a known granulation method.

Adjustment of the conditions during the polymerization or post treatment enables adjustment of physical properties of the resulting PTFE.

In emulsion polymerization, for example, the endothermic peak temperature can be increased, the standard specific gravity can be lowered, and the melt viscosity can be increased by reducing the amount of the polymerization initiator used, reducing the amount of the chain transfer agent used, or using a radical scavenger.

In the post treatment of the emulsion polymerization, the decomposition temperature can be increased by setting the drying temperature to 150° C. or higher.

In suspension polymerization, the endothermic peak temperature can be increased, the standard specific gravity can be lowered, and the melt viscosity can be increased by reducing the amount of the polymerization initiator used, reducing the amount of the chain transfer agent used, or preferably not using the chain transfer agent. In the post treatment, the decomposition temperature can be increased by performing washing and setting the drying temperature to 150° C. or higher.

As a method for molding the raw-material PTFE, in the case of using a powder obtained by emulsion polymerization, for example, the raw-material PTFE powder can be mixed with an extrusion aid and then paste extrusion molded. The extrusion aid can be removed by drying. Compression molding of the raw-material PTFE powder is also preferred.

In the case of using a powder obtained by suspension polymerization, for example, a molding method such as compression molding, ram extrusion molding, or isostatic compression molding can be used.

The PTFE molded article may be processed by machining such as cutting to produce a molded article having a desired shape. For example, a PTFE sheet can be obtained by cutting the PTFE molded article.

The firing can be performed, for example, by heating the molded article at a temperature of 350° C. to 380° C. for 0.5 to 50 hours.

The firing may include a section in which the temperature drop rate from 370° C. to 250° C. is 25° C./hr or more, and preferably includes a section in which the temperature drop rate is more than 25° C./hr. Such a section is preferably included in the cooling step after heating.

The temperature drop rate is more preferably 30° C./hr or more, still more preferably 45° C./hr or more, further preferably 55° C./hr or more, particularly preferably 65° C./hr or more. Cooling (quenching) by directly placing the fired article in water is also preferred.

By setting the temperature drop rate within the above range, the water vapor transmission coefficient can be easily set within the above range. The heat of crystallization can be also easily set within the above range.

In the case where the raw-material PTFE used has a relatively high molecular weight, the temperature drop rate is preferably set to a low level.

The gasket of the disclosure is a member used to prevent the leakage of liquid or gas or the intrusion of liquid or gas from the outside in the subject (e.g., device) to which the gasket is applied.

The gasket of the disclosure may have any shape such as a ring shape. The gasket of the disclosure may have a shape such as a circle, an ellipse, or a rectangle with rounded corners in a plan view, and may have a through-hole in the center.

The gasket of the disclosure excellent in water vapor barrier properties can be applied to any application in which prevention of the leakage or intrusion of water is desired. In particular, the gasket of the disclosure is suitably used in an electrochemical device.

A usage form of the gasket according to an embodiment of the disclosure in an electrochemical device is described with reference to the drawing.

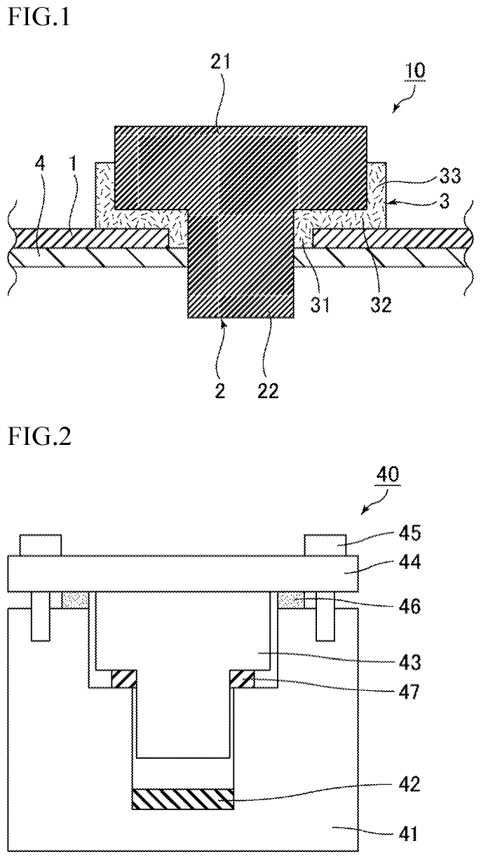

An electrochemical device 10 (such as a sealed type rectangular secondary battery) in FIG. 1 includes an outer can (not illustrated) and a lid 1. An electric element (not illustrated) such as a power generator is housed inside the outer can, and the opening of the outer can is hermetically sealed with the lid 1.

The lid 1 is provided with an external terminal 2 (positive electrode terminal or negative electrode terminal). Externally generated power is supplied to the electric element via the external terminal 2 for storage, and the stored power is supplied to an external load via the external terminal 2.

A gasket 3 is provided between the external terminal 2 and the lid 1 for sealing and insulation. The gasket 3 corresponds to the gasket of the disclosure.

An insulating plate 4 is provided on the lid 1 to electrically insulate the external terminal 2 from the lid 1.

The external terminal 2 has a terminal head 21 having a rectangular parallelepiped block shape and a columnar shaft 22. The shaft 22 protrudes from the lower surface (on the inner side of the electrochemical device) of the terminal head 21.

As illustrated in FIG. 1, the gasket 3 has a cylinder portion 31, a flange portion 32 that extends radially outward from one end of the opening of the cylinder portion 31, and a side wall portion 33 that rises from the periphery of the flange portion 32.

The cylinder portion 31 is fitted onto the shaft 22 of the external terminal 2, and the inner circumferential surface of the cylinder portion 31 is in contact with the outer circumferential surface of the shaft 22. The cylinder portion 31 is inserted into the through hole of the lid 1, and the outer circumferential surface of the cylinder portion 31 is in contact with the inner circumferential surface of the through hole of the lid 1.

The flange portion 32 is sandwiched between the lid 1 and the external terminal 2, with one contact surface of the flange portion 32 being in contact with the bottom surface of the external terminal 2 and the other contact surface of the flange portion 32 being in contact with the top surface of the lid 1.

The gasket 3 comes into contact with the external terminal 2 and the lid 1 with the cylinder portion 31 and the flange portion 32 of the gasket 3 in a compressed state, thereby ensuring the hermeticity of the electrochemical device.

Examples of the electrochemical device to which the gasket of the disclosure is applicable include batteries and capacitors.

Examples of batteries include secondary batteries such as lithium ion batteries.

The gasket may be used in any capacitor. An electrochemical capacitor is preferred. Examples of electrochemical capacitors include electric double layer capacitors, hybrid capacitors, and redox capacitors. Examples of hybrid capacitors include sodium ion capacitors, lithium ion capacitors, and magnesium ion capacitors. Among these, electric double layer capacitors are particularly preferred.

The gasket of the disclosure is suitably used as a gasket for a battery, and is particularly suitably used as a gasket for a secondary battery such as a lithium-ion battery.

The secondary battery may be a secondary battery including an electrolyte solution or may be a solid-state secondary battery.

The solid-state secondary battery herein is a secondary battery containing a solid electrolyte. It may be a semi-solid-state secondary battery containing, as an electrolyte, a solid electrolyte and a liquid component, or an all-solid-state secondary battery containing a solid electrolyte alone as an electrolyte.

The gasket of the disclosure is preferably in contact with an electrolyte, that is, the gasket of the disclosure preferably has a surface that contacts the electrolyte. The gasket of the disclosure having excellent water vapor barrier properties can reduce or prevent intrusion of water into the electrolyte when used in contact with the electrolyte.

The electrolyte here encompasses not only the electrolyte itself provided in the electrochemical device, but also substances derived from the electrolyte, and may be liquid, solid, or gas. The gas encompasses, for example, gas resulting from the volatilization of the electrolyte or gas generated by the decomposition of the electrolyte solution during charging and discharging.

The electrochemical device of the disclosure preferably includes a non-aqueous electrolyte solution. The gasket of the disclosure is preferably used in contact with a non-aqueous electrolyte solution, that is, the gasket of the disclosure preferably has a surface that contacts the non-aqueous electrolyte solution.

The non-aqueous electrolyte solution used may be a solution obtained by dissolving a known electrolyte salt in a known organic solvent for dissolving an electrolyte salt.

Any organic solvents for dissolving electrolyte salts may be used. One or more of known hydrocarbon solvents such as propylene carbonate, ethylene carbonate, butylene carbonate, γ-butyrolactone, 1,2-dimethoxyethane, 1,2-diethoxyethane, dimethyl carbonate, diethyl carbonate, and ethyl methyl carbonate; and fluorine solvents such as fluoroethylene carbonate, fluoroether, and fluorinated carbonate can be used.

Examples of electrolyte salts include LiClO₄, LiAsF₆, LiBF₄, LiPF₆, LiN(SO₂CF₃)₂, LiN(SO₂C₂F₅)₂, LiCl, LiBr, CH₃SO₃Li, CF₃SO₃Li, and cesium carbonate. In order to achieve favorable cycle characteristics, preferred is LiPF₆, LiBF₄, LiN(SO₂CF₃)₂, LiN(SO₂C₂F₅)₂, or a combination of any of these.

The concentration of the electrolyte salt is preferably 0.8 mol/L or higher, more preferably 1.0 mol/L or higher. The upper limit is usually 1.5 mol/L, though it depends on the organic solvent for dissolving an electrolyte salt used.

The solid electrolyte used in a solid-state secondary battery may be a sulfide-based solid electrolyte or an oxide-based solid electrolyte. In particular, a sulfide-based solid electrolyte has an advantage of being flexible.

The sulfide-based solid electrolyte is not limited. The sulfide-based solid electrolyte used may be any one selected from Li₂S—P₂S₅, Li₂S—P₂S₃, Li₂S—P₂S₃—P₂S₅, Li₂S—SiS₂, LiI—Li₂S—SiS₂, LiI—Li₂S—P₂S₅, LiI—Li₂S—P₂O₅, LiI—Li₃PO₄—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄, Li₄₋ₓGe₁₋ₓPₓS₄ (X=0.6 to 0.8), Li_{4+y}Ge_{1-y}Ga_{y}S₄ (y=0.2 to 0.3), LiPSCl, LiCl, Li_{7-x-2y}PS_{6-x-y}Clₓ (0.8≤x≤1.7, 0<y≤−0.25x+0.5), and Li₁₀SnP₂S₁₂, or a mixture of two or more thereof.

The sulfide-based solid electrolyte preferably contains lithium. Sulfide-based solid electrolytes containing lithium are used in solid-state batteries in which lithium ions are used as carriers, and are particularly preferred in that they provide electrochemical devices having high energy density.

The oxide-based solid electrolyte is preferably a compound that contains an oxygen atom (O), has conductivity of metal ions belonging to Group 1 or Group 2 of the periodic table, and has electronic insulating properties.

Specific examples of the compound include LiₓₐLa_{ya}TiO₃ (xa=0.3 to 0.7, ya=0.3 to 0.7) (LLT), Li_{xb}La_{yb}Zr_{zb}M^{bb}_{mb}O_{nb} (wherein M^{bb} includes at least one element selected from Al, Mg, Ca, Sr, V, Nb, Ta, Ti, Ge, In, and Sn; xb satisfies 5≤xb≤10; yb satisfies 1≤yb≤4; zb satisfies 1≤zb≤4; mb satisfies 0≤mb≤2; and nb satisfies 5≤nb≤20), Li_{xc}B_{yc}Mo^{cc}_{zc}O_{nc} (wherein M^{cc} includes at least one element selected from C, S, Al, Si, Ga, Ge, In, and Sn; xc satisfies 0≤xc≤5; yc satisfies 0≤yc≤1; zc satisfies 0≤zc≤1; and nc satisfies 0≤nc≤6), Li_{xd}(Al,Ga)_{yd}(Ti,Ge)_{zd}Si_{ad}P_{md}O_{nd} (1≤xd≤3, 0≤yd≤2, 0≤zd≤2, 0≤ad≤2, 1≤md≤7, and 3≤nd≤15), Li₍₃₋₂ₓₑ₎M^{ee}ₓₑD^{ee}O (wherein xe is a number of 0 or greater and 0.1 or smaller, M^{ee} is a divalent metal atom, D^{ee} is a halogen atom or a combination of two or more halogen atoms), Li_{xf}Si_{yf}O_{zf} (1≤xf≤5, 0<yf≤3, and 1≤zf≤10), Li_{xg}S_{yg}O_{zg} (1≤xg≤3, 0<yg≤2, and 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w<1), Li_{3.5}Zn_{0.25}GeO₄ having a lithium super ionic conductor (LISICON) crystal structure, La_{0.51}Li_{0.34}TiO_{2.94} having a perovskite crystal structure, La_{0.55}Li_{0.35}TiO₃, LiTi₂P₃O₁₂ having a natrium super ionic conductor (NASICON) crystal structure, Li_{1+xh+yh}(Al,Ga)ₓₕ(Ti,Ge)₂₋ₓₕSi_{yh}P_{3-yh}O₁₂ (0≤xh≤1 and 0≤yh≤1), and Li₇La₃Zr₂O₁₂(LLZ) having a garnet crystal structure. Ceramic materials in which element substitution is performed for LLZ are also known. Examples thereof include Li_{6.24}La₃Zr₂Al_{0.24}O_{11.98} and Li_{6.25}Al_{0.25}La₃Zr₂O₁₂ in which partial element substitution using Al is performed for LLZ, Li_{6.6}La₃Zr_{1.6}Ta_{0.4}O₁₂ in which partial element substitution using Ta is performed for LLZ, and Li_{6.75}La₃Zr_{1.75}Nb_{0.25}O₁₂ in which partial element substitution using Nb is performed for LLZ. Other examples include LLZ-based ceramic materials in which element substitution using at least one of magnesium (Mg) and A (A includes at least one element selected from the group consisting of calcium (Ca), strontium (Sr), and barium (Ba)) is performed for LLZ. Phosphorus compounds containing Li, P and O are also desirable. Examples include lithium phosphate (Li₃PO₄), LiPON in which one or more oxygen atoms in lithium phosphate are replaced with nitrogen, and LiPOD¹ (wherein D¹ includes at least one selected from Ti, V, Cr, Mn, Fe, Co, Ni, Cu, Zr, Nb, Mo, Ru, Ag, Ta, W, Pt, Au, and the like). LiA¹ON (wherein A¹ includes at least one selected from Si, B, Ge, Al, C, Ga, and the like) can also be preferably used. Specific examples include Li₂O—Al₂O₃—SiO₂—P₂O₅—TiO₂—GeO₂ and Li₂O—Al₂O₃—SiO₂—P₂O₅—TiO₂.

The oxide-based solid electrolyte preferably contains lithium. Oxide-based solid electrolytes containing lithium are used in solid-state batteries in which lithium ions are used as carriers, and are particularly preferred in that they provide electrochemical devices having high energy density.

The oxide-based solid electrolyte is preferably an oxide having a crystal structure. Oxides having a crystal structure are particularly preferred in terms of good Li ion conductivity. The oxide having a crystal structure may be of perovskite type (e.g., La_{0.51}Li_{0.34}TiO_{2.94}), NASICON type (e.g., Li_{1.3}Al_{0.3}Ti_{1.7}(PO₄)₃), or garnet type (e.g., Li₇La₃Zr₂O₁₂ (LLZ)). Preferred among these is the garnet type.

An electrochemical device including the gasket of the disclosure is also one aspect of the disclosure.

It should be appreciated that a variety of modifications and changes in the structure and other details may be made to the aforementioned embodiments without departing from the spirit and scope of the claims.

The disclosure (1) relates to a gasket containing polytetrafluoroethylene exhibiting non-melt-moldability, the gasket having a water vapor transmission coefficient of 0.020 g/1000 hr or less.

The disclosure (2) relates to the gasket according to the disclosure (1), wherein the polytetrafluoroethylene includes a modified polytetrafluoroethylene.

The disclosure (3) relates to the gasket according to the disclosure (1) or (2), wherein the polytetrafluoroethylene includes a modified polytetrafluoroethylene containing a tetrafluoroethylene unit and at least one modifying monomer unit selected from the group consisting of a perfluoro (alkyl vinyl ether) unit and a hexafluoropropylene unit.

The disclosure (4) relates to the gasket according to the disclosure (2) or (3), wherein the modified polytetrafluoroethylene has an amount of modification of 0.001 to 1.0% by mass.

The disclosure (5) relates to the gasket according to any one of the disclosures (1) to (4), wherein the gasket has a specific gravity of 2.130 or more and 2.180 or less.

The disclosure (6) relates to the gasket according to any one of the disclosures (1) to (5), wherein the gasket is in contact with an electrolyte.

The disclosure (7) relates to the gasket according to any one of the disclosures (1) to (6), wherein the gasket has a degree of crystallinity of 35 to 60%.

The disclosure (8) relates to the gasket according to any one of the disclosures (1) to (7), wherein the gasket has a scattering intensity of 800 to 1600.

The disclosure (9) relates to an electrochemical device including the gasket according to any one of the disclosures (1) to (8).

The disclosure (10) relates to a gasket for an electrochemical device, containing polytetrafluoroethylene exhibiting non-melt-moldability, the gasket having a specific gravity of 2.130 or more and 2.180 or less.

The disclosure (11) relates to the gasket according to the disclosure (10), wherein the gasket has a degree of crystallinity of 65% or less and a scattering intensity of 800 or more.

The disclosure (12) relates to a gasket for an electrochemical device, containing polytetrafluoroethylene exhibiting non-melt-moldability, the gasket having a degree of crystallinity of 65% or less and a scattering intensity of 800 or more.

The disclosure (13) relates to an electrochemical device including the gasket according to any one of the disclosures (1) to (12), the gasket containing the polytetrafluoroethylene in an amount of 99.9% by mass or more.

The disclosure (14) relates to an electrochemical device including the gasket according to any one of the disclosures (1) to (13), the gasket having a specific gravity of 2.140 to 2.170.

The disclosure (15) relates to an electrochemical device including the gasket according to any one of the disclosures (1) to (14), wherein the polytetrafluoroethylene in the gasket includes a tetrafluoroethylene homopolymer or a modified PTFE containing a modifying monomer unit in an amount of 0.01 to 0.10% by mass based on all polymerized units.

### EXAMPLES

The disclosure is described in more detail below with reference to examples, but is not limited to these examples.

Physical properties were measured by the following methods.

### <Amount of Modifying Monomer>

A sample was press-molded into a thin-film disc and the thin-film disc was subjected to FT-IR measurement, so that infrared absorbances were obtained. The amount of PPVE was determined by multiplying the ratio (absorbance at 995 cm⁻¹)/(absorbance at 935 cm⁻¹) by 0.14.

### <Standard Specific Gravity (SSG)>

The SSG was determined by the water displacement method in conformity with ASTM D792 using a sample molded in conformity with ASTM D4895-89.

### <Melt Moldability>

In conformity with ASTM D1238 using a melt indexer, the mass (g/10 min) of a polymer flowing out of a nozzle (inner diameter: 2.095 mm, length: 8 mm) per 10 minutes at 372° C. and a load of 5000 g (total load) was measured. Those having an MFR of 0.10 g/10 min or more were judged to be melt-moldable, and those having an MFR of less than 0.10 g/10 min were judged to be not melt-moldable (exhibiting non-melt-moldability).

### Gasket A

A PTFE powder (a modified PTFE containing 0.08% by mass of PPVE unit obtained by suspension polymerization, SSG=2.150) exhibiting non-melt-moldability was compression molded under molding conditions of a pressure of 30 MPa and a holding time of five minutes, and the temperature was raised to 370° C. at a rate of 50° C./hr in an electric furnace, and heat treatment was carried out at 370° C. for 5.5 hours. Thereafter, the resulting molded article was cooled to room temperature at a rate of 50° C./hr to obtain a ring-shaped gasket A with a rectangular cross section having an inner diameter of 14.3 mm, an outer diameter of 17.7 mm, and a height of 1.6 mm.

### Gasket B

A ring-shaped gasket B was obtained as in the case of gasket A, except that the molded article after heat treatment was immersed in ice water to set the temperature drop rate during cooling to about 300° C./hr.

### Gasket C

A ring-shaped gasket C was obtained as in the case of gasket A, except that the temperature drop rate during cooling was set to 25° C./hr.

### Gasket D

A ring-shaped gasket D was obtained as in the case of gasket C, except that a TFE homopolymer (SSG=2.165) obtained by suspension polymerization was used as the PTFE powder exhibiting non-melt-moldability.

### Gasket E

A ring-shaped gasket E was obtained as in the case of gasket C, except that a modified PTFE (PPVE content of 0.08% by mass, SSG=2.160) obtained by suspension polymerization was used as the PTFE powder exhibiting non-melt-moldability.

The water vapor transmission coefficients of the gaskets obtained were measured by the following method. The gasket was removed from the test jig after the water vapor transmission test, and the specific gravity, degree of crystallinity, and scattering intensity of the gasket were measured. The results are shown in Table 1.

### <Water Vapor Transmission Test>

As shown in FIG. 2, 2 g of water 42 was placed in an aluminum alloy cup 41. A gasket 47 was placed between the cup 41 and a gasket compression jig 43, and a lid 44 was fastened with a bolt 45 to compress the gasket 47. A spacer 46 was installed between the lid 44 and the cup 41, allowing the compression ratio of the gasket 47 to be adjusted to 15% in Example 1 and Comparative Example 1, and 40% in Examples 2 to 4.

The compression ratio was determined using the following formula.

$$( Compression ratio of gasket ( \% ) ) = \{ 1 - ( Distance of gap ( where gasket is placed ) between cup 41 and gasket compression jig 43 ) / ( height of gasket before compression ) \} \times 100$$

The mass of a transmission test jig 40 thus obtained was measured. The transmission test jig 40 was placed in an electric furnace at 80° C. and left for 1000 hours. The transmission test jig 40 was then taken out and left at room temperature for two hours, followed by measurement of the mass. The water vapor transmission coefficient was determined using the following formula. The above operation was repeated three times to determine the average of the water vapor transmission coefficient. The average values are shown in Table 1.

$$Water vapor transmission coefficient ( g / 1000 hr ) = ( Mass of transmission test jig before heating ) - ( Mass of transmission test jig after heating )$$

### <Specific Gravity>

The specific gravity was measured by the water displacement method in conformity with ASTM D792.

### <Degree of Crystallinity>

The degree of crystallinity was measured using an X-ray diffractometer (Ultima III, available from Rigaku Corporation) by a multiple peak separation method under the following measurement conditions. A measurement sample with a thickness of 40 μm or more was set in a sample holder, and the peaks of the crystalline and amorphous portions of the obtained diffraction spectrum were separated into independent peaks. The integrated intensity (area) of each peak was determined to calculate the degree of crystallinity.

### Measurement Conditions

TABLE 3

| Radiation source: | CuKα radiation: λ = 1.5418 Å |
|---|---|
| Output power: | 40 kV/40 mA |
| Measurement range: | 5° to 55° |
| STEP width: | 0.02° |

### <Scattering Intensity>

The scattering intensity was measured using a small angle X-ray diffractometer (RINT2500, available from Rigaku Corporation) under the following measurement conditions, and the scattering intensity at a scattering vector q of 0.07 nm⁻¹ was defined as the scattering intensity.

### Measurement Conditions

TABLE 4

| | |
|---|---|
| Radiation source: | CuKα radiation: λ = 1.5418 Å |
| Output power: | 50 kV/300 mA |
| Detector: | Scintillation counter |

TABLE 5

| | | | | | | | Comparative |
|---|---|---|---|---|---|---|---|
| | Example 1 | Example 2 | Example 3 | Example 4 | Example 5 | Example 6 | Example 1 |
| Gasket | A | B | A | C | D | E | B |
| Compression ratio (%) | 15 | 40 | 40 | 40 | 40 | 40 | 15 |
| Water vapor transmission | 0.010 | 0.007 | 0.002 | 0.012 | 0.012 | 0.012 | 0.023 |
| coefficient (g/1000 hr) | | | | | | | |
| Specific gravity | 2.151 | 2.148 | 2.153 | 2.185 | 2.165 | 2.159 | 2.184 |
| Degree of crystallinity (%) | 51.3 | 40.4 | 53.5 | 61.1 | 53.1 | 50.2 | 62.5 |
| Scattering intensity | 832 | 1468 | 1430 | 1249 | 1422 | 1398 | 717 |

### REFERENCE SIGNS LIST

10: electrochemical device
1: lid
2: external terminal
21: terminal head
22: shaft
3: gasket
31: cylinder portion
32: flange portion
33: side wall portion
4: insulating plate
40: transmission test jig
41: cup
42: water
43: gasket compression jig
44: lid
45: bolt
46: spacer
47: gasket

1. A gasket for an electrochemical device, comprising polytetrafluoroethylene exhibiting non-melt-moldability,
the gasket having a specific gravity of 2.130 or more and 2.180 or less.

2. The gasket according to claim 1,
wherein the gasket has a degree of crystallinity of 65% or less and a scattering intensity of 800 or more.

3. The gasket according to claim 1,
wherein the polytetrafluoroethylene is contained in an amount of 99.9% by mass or more.

4. The gasket according to claim 1,
wherein the gasket has a specific gravity of 2.140 to 2.170.

5. The gasket according to claim 1,
wherein the polytetrafluoroethylene includes a tetrafluoroethylene homopolymer or a modified PTFE containing a modifying monomer unit in an amount of 0.01 to 0.10% by mass based on all polymerized units.
